(19) United States
(12) Patent Application Publication
(10) Pub. No.: US 2019/0184420 A1
(43) Pub. Date: Jun. 20, 2019

(54) PAINT TOUCHUP

(71) Applicant: John I. Andersen, Idaho Falls, ID (US)

(72) Inventor: John I. Andersen, Idaho Falls, ID (US)

(21) Appl. No.: 15/847,855

(22) Filed: Dec. 19, 2017

(51) Int. Cl. B05C 17/005; B05C 5/02

(52) U.S. Cl. CPC B05C 17/00593; B05C 5/02; B05C 17/00516

(57) ABSTRACT

A syringe can be used to store paint and then apply the paint to a defect on a painted surface. In embodiments, the syringe is filled at the time that the paint is first used, the syringe then being stored for later use. Embodiments of the present disclosure include using a paint applicator as disclosed herein by pushing the syringe plunger to expel paint at a wall defect such as a nail hole.

### BACKGROUND

Often, interior or exterior paint can become marred when a painted wall is scratched or struck by an object. Damaged paint can often flake off, leaving unsightly defects in the wall. Paint can also be damaged by nails leaving unsightly nail holes. Other similar incidents can likewise damage painted walls, ceilings, or other painted surfaces.

Damaged paint and/or nail holes are typically undesirable and can ruin the appearance of painted wall surfaces. One may repair damaged paint by filling in the hole or defect with a filler material such as spackle or other putty-like compounds, priming, sanding, and painting. In some cases of shallow dents, only paint is used.

One common difficulty in repairing damaged paint is matching the color of the surrounding paint, as new paint having even slightly different tint might stand out from the original, surrounding paint. However, many people do not keep the original paint because of limited storage space, messiness, and other inconveniences associated with storing paint cans, buckets, and other containers.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts a paint applicator syringe according to one embodiment of the present disclosure;

FIG. 2 depicts a paint applicator syringe with a tapered tip according to one embodiment of the present disclosure;

FIG. 3 depicts a paint applicator syringe with a cap according to one embodiment of the present disclosure;

FIG. 4 depicts a nail hole in a painted surface;

FIG. 5 depicts application of paint to a nail hole according to one embodiment of the present disclosure; and

FIG. 6 depicts a fixed painted wall surface.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Embodiments of the present disclosure include a paint container and applicator that can be used to store paint and then to apply paint to defects on painted surfaces.

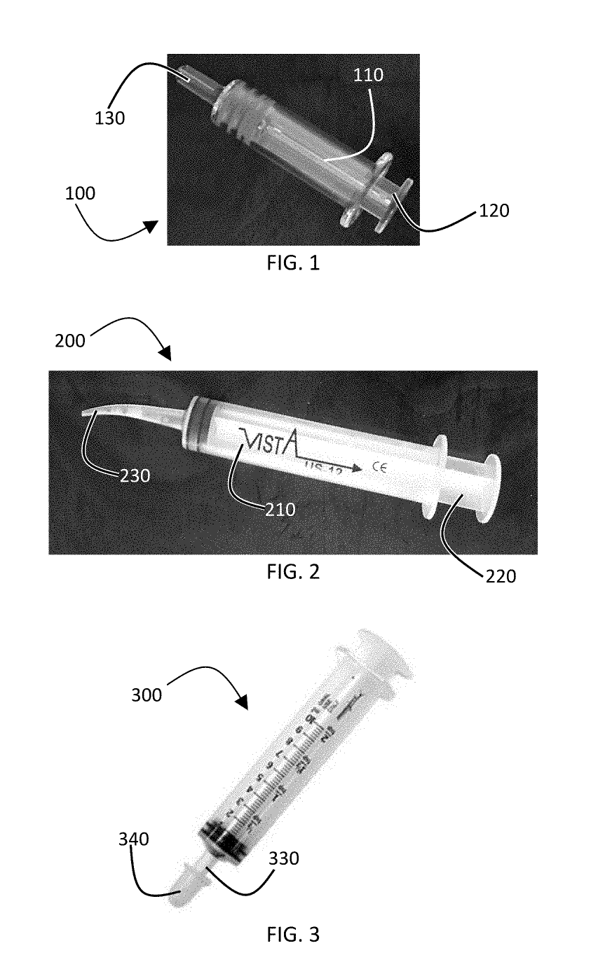

Referring to FIG. 1, one embodiment of a paint applicator comprises a syringe 100. Syringe 100 comprises a barrel 110 adapted to store paint or like substances and a plunger 120. In embodiments, barrel 110 and plunger 120 both have a plastic body. Embodiments of plunger 120 include a rubber piston that acts as a seal around the inside circumference of barrel 110. Syringe 100 includes outlet nozzle 130. Embodiments of outlet nozzle 130 include a tip having a diameter small enough to fit within a nail hole. In other embodiments, nozzle 130 has a tip with a diameter approximately the same as a nail hole.

FIG. 2 depicts a paint applicator syringe 200 according to another embodiment of the present disclosure. Syringe 200 includes barrel 210, plunger 220, and tapered tip 230. Referring to FIG. 3, embodiments of syringe 300 include cap 340 adapted to seat over tip 330, thereby forming an air-tight seal to preserve the contents of the syringe 300.

Other embodiments include a syringe having a Luer taper (also generally known as a Luer lock) at the outlet tip as a fitting. Said fitting may be used to attach an outlet tube, an outlet nozzle, a cap, and the like. Other types of fittings may likewise be used. In one embodiment, the outlet tip comprises a hole having a diameter of approximately 1/16 of an inch. In one embodiment, a cap fits on a fitting at the tip of the syringe by engaging a threaded connection such as a Luer lock. In other embodiments, a cap slides onto the tip.

In operation, a syringe may be filled with a selected paint (or like coating) at the time of painting one or more surfaces. The syringe may be used as a long-term storage for the paint to ensure that paint having the matching tint is maintained and available to touch up defects. In embodiments, the syringe may be filled by inserting the tip into a volume of liquid paint and pulling the plunger upward, thereby allowing a vacuum effect to pull paint into the syringe barrel. In some embodiments, the plunger is removed from the barrel, paint is poured into the barrel, and then the plunger is replaced.

Following filling the syringe with paint, a cap may be placed over the syringe tip to seal the container. A label may be applied and/or written on the side of the syringe to indicate the contents of the syringe.

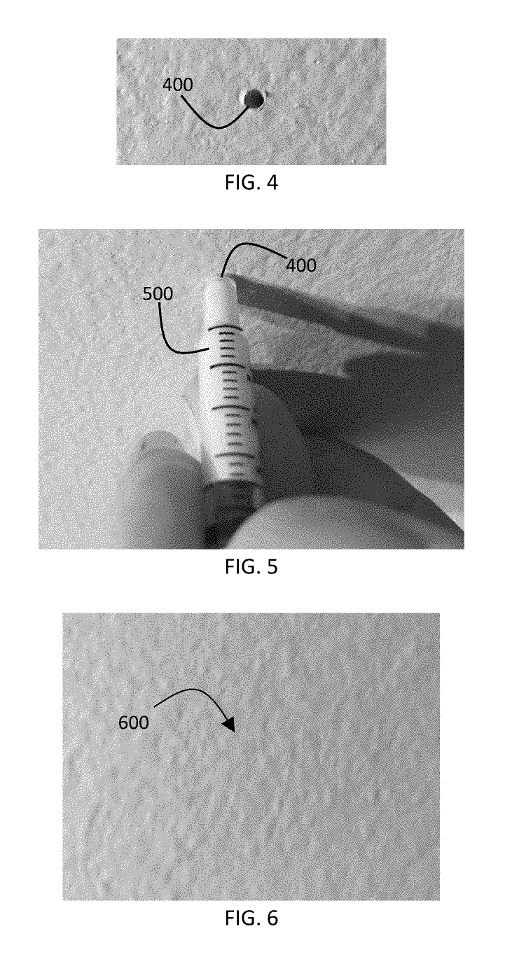

Later, the syringe may be used to fix a defect in a wall or ceiling. Referring to FIG. 4, a nail hole 400 is identified and selected for repair. To do so, referring to FIG. 5, one may remove the cap from the syringe 500 having the appropriate paint, insert the syringe tip into the nail hole 400 or place the tip at the nail hole 400, and press the plunger, thereby injecting paint into the nail hole 400. Upon filling the nail hole 400 with paint, the syringe 500 may be capped and stored again, ready for a subsequent use. Referring to FIG. 6, upon drying, the newly injected paint 600 may blend in with the surrounding wall surfaces.

According to embodiments, a syringe may include a barcode or other identifying printed or labeled information that indicates the paint color or other relevant details.

In some embodiments, a syringe includes printed or labeled information that includes contact information for a business and/or person, such that the syringe itself acts as a business card. For example, a real estate agent may hand out an empty syringe to a new homeowner, the syringe having the agent's name and contact information. The homeowner may use the syringe as described above and the agent may be satisfied with the assumption that the syringe will not be discarded (as a business card may be) due to the syringe's usefulness. Likewise, syringes may be printed with contact and/or marketing information on it for various purposes.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A paint applicator comprising:
a syringe having a syringe barrel and
a volume of liquid paint within the syringe barrel.

2. The paint applicator of claim 1, further comprising a cap covering a tip of the syringe.

3. A method of applying paint comprising:
providing a syringe with liquid paint therein;
holding a tip of the syringe at a painted surface defect; and
pushing a plunger of the syringe, thereby expelling the paint at the defect.

4. The method of claim 3, wherein the painted surface defect comprises a nail hole.
